(19) United States
(12) Patent Application Publication
(10) Pub. No.: US 2010/0144913 A1
(43) Pub. Date: Jun. 10, 2010

(54) ANTIMICROBIALLY MODIFIED MELAMINE/FORMALDEHYDE FOAM

(75) Inventors: Armin Alteheld, Bad Kreuznach (DE); Klaus Hahn, Kirchheim (DE); Christof Möck, Mannheim (DE); Bernhard Vath, Mannheim (DE); Jens-Uwe Schierholz, Bensheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/530,535

(22) PCT Filed: Mar. 3, 2008
(86) PCT No.: PCT/EP2008/052560

§ 371 Date: Sep. 9, 2009

(30) Foreign Application Priority Data
Mar. 12, 2007 (EP) 07103918.4

(51) Int. Cl. C08K 3/08; C08J 9/06; C08K 5/19; C08K 5/16; C08K 5/05; C08K 5/3492; A47L 13/16

(52) U.S. Cl. 521/88; 521/92; 521/90; 521/94; 521/95; 15/244.4

(57) ABSTRACT

The present invention concerns a process for producing a foam comprising at least one antimicrobial active, comprising the steps of:
(1) preparing a solution or dispersion comprising at least one precondensate of the foam to be produced and at least one antimicrobial active,
(2) foaming the precondensate by heating the solution or dispersion of step (1) to obtain a foam comprising at least one antimicrobial active, and
(3) heat treating the foam obtained in step (2) at a temperature in the range from 120 to 300° C.,

a foam thus produced, a shaped article comprising such a foam and the use of such a foam for thermal and acoustical insulation of buildings and parts of buildings, thermal and acoustical insulation of the interiors of land, air and sea vehicles, low-temperature insulation, as an insulating wall cladding, as an insulating and shock-absorbing packaging material, as abrasive cleaning, grinding and polishing sponges, in the hygiene sector and as a filter material.

The present invention relates to a process for producing a foam comprising at least one antimicrobial active, a foam thus produced, a shaped article comprising the present foam and the use of this foam for thermal and acoustical insulation, as packaging material, as cleaning sponges, in the hygiene sector and as a filter material, for example in air-conditioning systems.

Materials, including plastics, endowed with antimicrobial actives are already known from the prior art.

US 2005/0154361 A1 discloses a solid surface material comprising an antimicrobially active reagent in a resin matrix, the antimicrobial reagent being a chitosan-metal complex. The material is produced by adding the antimicrobially active reagent to the resin components, mixing these with further ingredients and polymerizing. US 2005/0154361 A1 discloses a solid surface material, for example as materials for covering floors or walls. This document does not disclose a flexible foam comprising an antimicrobially active reagent.

DE 1 180 486 discloses various plastics endowed with antimicrobially active reagents. Suitable plastics are polyvinyl chloride, polystyrene, polyester resins, natural and synthetic rubbers, polyurethanes, also cellulose and its conversion products, such as paper, cellulose acetate and cellulose acetate butyrate. According to this document, the antimicrobially active compound can be added during production, for example during a polycondensation. DE 1 180 486 discloses plastics comprising antimicrobial substances and processed into films, profiles and sheets. The cited document does not disclose any antimicrobially endowed foams.

WO 2005/054566 A1 discloses a composition for inhibiting the growth of microorganisms on non-natural fibers, comprising at least one self-crosslinking resin, at least one catalyst, at least one antimicrobially active reagent that is reactive with the resin, and water. The non-natural fibers of this document are fibers based on polyesters, polyamides, polypropylene, polyurethanes and cellulose acetate. The antimicrobially active reagent is applied to the non-natural fibers through the self-crosslinking resin without ionic or covalent bonds existing between the fibers and the reagent. WO 2005/054566 A1 does not disclose foams comprising antimicrobial actives.

U.S. Pat. No. 6,375,964 B1 discloses a cleaning material for cleansing surfaces comprising a foamed cellular structure comprising an antimicrobially active composition. The foamed matrix is a polyurethane foam and the antimicrobial composition comprises a source of silver ions. The polyurethane foam of U.S. Pat. No. 6,375,964 B1 is produced by forming the polyurethane foam from a stoichiometric mixture of diisocyanate and polyol and incorporating the antimicrobially active composition therein. U.S. Pat. No. 6,375,964 B1 does not disclose a process for producing a foam comprising at least one antimicrobial active wherein the active is added to a solution or dispersion of the foam precondensate, and subsequently foamed. Nor does the cited document disclose any foam based on a melamine-formaldehyde condensation product comprising at least one antimicrobial active uniformly distributed therein.

US 2005/0241480 A1 discloses a porous filter medium for extracting hydrocarbons from vapors emitted from motorized vehicles. The porous filter medium is a foam based on a melamine-formaldehyde condensation product coated with antimicrobially active substances. Since the antimicrobial active is applied to the foam after the foam has been produced, the antimicrobial active is merely situated on the surface of the foam. Furthermore, the production of such a coated foam comprises a further step, namely that of coating the foam.

It is an object of the present invention to provide a process for producing a foam comprising at least one antimicrobial active whereby the antimicrobial active is uniformly distributable in the entire foam. The process shall further make it unnecessary to have an additional step, a step of applying an antimicrobial active to the final foam. It is a further object of the present invention to provide a foam which, owing to the distribution of the antimicrobial active therein, exhibits gradual release of the active from the foam matrix material.

We have found that these objects are achieved by a process for producing a foam comprising at least one antimicrobial active, comprising the steps of:
(1) preparing a solution or dispersion comprising at least one precondensate of the foam to be produced and at least one antimicrobial active,
(2) foaming the precondensate by heating the solution or dispersion of step (1) to obtain a foam comprising at least one antimicrobial active, and (3) heat treating the foam obtained in step (2) at a temperature in the range from 120 to 300° C.

The individual steps (1) to (3) will now be more particularly described:

Step (1):

Step (1) of the present process comprises preparing a solution or dispersion comprising at least one precondensate of the foam to be produced and at least one antimicrobial active.

So a precondensate, preferably a melamine-formaldehyde precondensate, is used as a starting material. Accordingly, in a preferred embodiment, the foam is a foam based on a melamine-formaldehyde condensation product.

Melamine-formaldehyde condensation products, as well as melamine, may comprise up to 50% and preferably up to 20% by weight of other thermoset-formers and, as well as formaldehyde, up to 50% and preferably up to 20% by weight of other aldehydes in cocondensed form. Particular preference is given to an unmodified melamine-formaldehyde condensation product. Useful thermoset-formers include for example alkyl- and aryl-substituted melamine, urea, urethanes, carboxamides, dicyandiamide, guanidine, sulfurylamide, sulfonamides, aliphatic amines, glycols, phenol and its derivatives.

Useful aldehydes include for example acetaldehyde, trimethylolacetaldehyde, acrolein, benzaldehyde, furfural, glyoxal, glutaraldehyde, phthalaldehyde and terephthalaldehyde. Further details concerning melamine-formaldehyde condensation products are to be found in Houben-Weyl, Methoden der organischen Chemie, Volume 14/2, 1963, pages 319 to 402.

The molar ratio of melamine-formaldehyde in the precondensate is generally in the range from 1:1 and 1:5. To produce particularly low-formaldehyde foams, the molar ratio is chosen in the range from 1:1.3 to 1:1.8 and a precondensate free of sulfite groups is used, as described in WO 01/94436 for example.

The melamine resins may comprise cocondensed sulfite groups, as can be accomplished for example by addition of 1% to 20% by weight of sodium hydrogen-sulfite in the course of the condensation of the resin. In a preferred embodiment, useful melamine resin precondensates for the purposes of the invention comprise no sulfite groups; that is, the sulfite group content should be below 1%, preferably below 0.1% and more preferably 0%.

The solution or dispersion comprising at least one precondensate of the foam to be produced and at least one antimicrobial active is obtainable in a conventional manner. In a preferred embodiment, the precondensate in question is prepared in water. The precondensate may be prepared in the presence of alcohols, for example methanol, ethanol or butanol, to obtain partially or completely etherified condensates. After the reaction has ended, the appropriate amount of the at least one antimicrobial active is added. The formation of ether groups has an effect on the solubility of the precondensate and on the mechanical properties of the fully cured material.

The at least one antimicrobial active present in the solution or dispersion prepared in step (1) of the present process is preferably selected from the group consisting of silver salts, copper salts, zinc salts, organic biocides and mixtures thereof.

Suitable silver salts are selected from the group consisting of silver nitrate, silver acetate and mixtures thereof. Suitable copper salts are selected from the group consisting of copper sulfate, copper acetate, copper nitrate, copper(I) chloride, copper(II) chloride and mixtures thereof. Suitable zinc salts are selected from the group consisting of zinc sulfate, zinc acetate, zinc chloride, zinc nitrate and mixtures thereof. It is very particularly preferable to use silver nitrate and/or silver acetate as antimicrobial active.

Colloidal dispersions of the metals mentioned can also be used. For instance possible discolorations due to the addition of silver salts can be avoided by using a colloidal dispersion of metallic silver.

In lieu of or in addition to the mentioned inorganic actives with an antimicrobial effect, organic biocides can be used. Examples of these substances are chioroisocyanurates, quaternary ammonium compounds (quats), hydantoins, chloromethylisothiazolinone, parabens, triclosan, 2-bromo-2-nitropropane-1,3-diol, phenoxyethanol or hexahydrotriazines. A preferred embodiment utilizes organic biocides as antimicrobial actives.

The antimicrobial active is present in the solution or dispersion in an amount which is preferably in the range from 0.0001% to 10% by weight and more preferably in the range from 0.001% to 1% by weight, all based on the precondensate.

In a further preferred embodiment, the solution or dispersion further comprises at least one emulsifier and/or at least one hardener.

The emulsifier used can be anionic, cationic and nonionic surfactants and mixtures thereof.

Useful anionic surfactants are diphenylene oxide sulfonates, alkane- and alkylbenzenesulfonates, alkylnaphthalenesulfonates, olefinsulfonates, alkyl ether sulfonates, fatty alcohol sulfates, ether sulfates, α-sulfofatty acid esters, acylaminoalkanesulfonates, acylisethionates, alkyl ether carboxylates, N-acylsarcosinates, alkyl- and alkyl ether phosphates.

Useful nonionic surfactants include alkylphenol polyglycol ethers, fatty alcohol polyglycol ethers, fatty acid polyglycol ethers, fatty acid alkanolamides, EO-PO block copolymers, amino oxides, glyceryl fatty acid esters, sorbitan esters and alkyl polyglycosides.

Useful cationic emulsifiers include alkyltriammonium salts, alkylbenzyldimethylammonium salts and alkylpyridinium salts.

The emulsifiers are preferably used in amounts of 0.2% to 5% by weight, based on the precondensate.

Useful hardeners include acidic compounds which catalyze the further condensation of the melamine resin. The amounts of these hardeners are in the range from 0.01% to 20% by weight and preferably in the range from 0.05% to 5% by weight, all based on the precondensate.

Suitable acidic compounds are inorganic and organic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

Depending on the choice of precondensate, the solution or dispersion comprises a blowing agent. The amount of blowing agent in the solution or dispersion depends on the density desired for the foam. In principle, the process of the present invention can utilize not only physical but also chemical blowing agents. Useful physical blowing agents include for example hydrocarbons, for example pentane, hexane, halogenated, more particularly chlorinated and/or fluorinated, hydrocarbons, for example methylene chloride, chloroform, trichloroethane, chlorofluorocarbons, hydrofluorochlorocarbons (HCFCs), alcohols, for example methanol, ethanol or isomers of propanol, ethers, ketones and esters, for example methyl formate, ethyl formate, methyl acetate or ethyl acetate, in liquid form or air and carbon dioxide as gases. Useful chemical blowing agents include for example isocyanates admixed with water, releasing carbon dioxide as the effective blowing agent. Also suitable are carbonates and bicarbonates in admixture with acids (likewise generating carbon dioxide), and also azo compounds, such as azodicarbonamide.

When the process of the present invention utilizes a foam based on a polyurethane, no additional blowing agent has to be added, since the polycondensation reaction between the isocyanate groups and the alcohol groups produces carbon dioxide, which acts as blowing agent.

In a preferred embodiment of the present invention, the solution or dispersion in step (1) of the present process further comprises at least one blowing agent.

This blowing agent is present in the solution or dispersion in an amount which is preferably in the range from 1% to 40% by weight, based on the precondensate. It is preferable to add a physical blowing agent having a boiling point between 0 and 80° C. When pentane is used as preferred blowing agent, then it is particularly preferable to use 5% to 15% by weight of pentane, based on the precondensate.

In a further preferred embodiment, the solution or dispersion prepared in step (1) is free of further added materials apart from the at least one precondensate of the foam to be produced, the at least one antimicrobial active, the at least one emulsifier, the at least one hardener and, if appropriate, at least one blowing agent. However, there are many purposes where it can be beneficial to add up to 20% by weight and preferably less than 10% by weight, based on the precondensate, of customary added materials, such as dyes, flame retardants, UV stabilizers, agents to reduce combustion gas toxicity or to promote carbonization. Since the foams produced according to the present invention are generally open-celled and able to take up water, it can be necessary for some applications, for example thermal insulation or acoustical absorption where condensation is likely, to add hydrophobicizers in amounts ranging from 0.2% to 5% by weight. Useful hydrophobicizers include for example silicones, paraffins, silicone surfactants, fluorosurfactants, aluminum stearates, hydrophobins or fluorocarbon resins.

In a further preferred embodiment, the concentration of the precondensate in the solution or dispersion prepared in step (1) of the process of the present invention is from 55% to 85% and more preferably from 63% to 80% by weight. The solution or dispersion prepared of the precondensate preferably has a viscosity in the range from 1 to 3000 dPas and more preferably in the range from 5 to 2000 dPas.

The at least one antimicrobial active and the, if appropriate, further added materials in the solution or dispersion are mixed, preferably homogeneously, with the solution or dispersion of the precondensate, at which point the blowing agent, present if appropriate, can be injected under pressure also. However, it is also possible to proceed from a solid, for example spray-dried, precondensate and to mix it with a, preferably, aqueous solution of the antimicrobial active and, if appropriate, further added materials. The mixing of the components can be carried out in a conventional manner, for example in an extruder. In a preferred embodiment, the solution or dispersion is discharged through a die and immediately thereafter heated in step (2) and expanded in the process of heating.

Step (2):

Step (2) of the present process comprises foaming the precondensate by heating the solution or dispersion from step (1) to obtain a foam comprising at least one antimicrobial active.

The heating of the solution or dispersion prepared in step (1) may be effected, in a preferred embodiment, via hot gases or high frequency irradiation, as described in EP-B 17671. It is particularly preferable for the requisite heating to be done by using ultra-high frequency irradiation as described in EP-B 37470. This dielectric radiation utilizes microwaves in the frequency range from 0.2 GHz to 100 GHz. It is particularly preferable to use the frequencies of 0.915, 2.45 and 5.8 GHz and it is very particularly preferred to use radiation having a frequency of 2.45 GHz. The source for the dielectric radiation is a magnetron, although a plurality of magnetrons can also be used at one and the same time. Care must be taken to ensure that the irradiating is done with a very homogeneous field distribution to avoid nonuniform heating and hence nonuniform foaming.

The irradiating is preferably carried out such that the power taken up by the solution or dispersion is 5 to 200 and preferably 9 to 120 kW, all based on one kilogram of solution or dispersion. If the power taken up is less, foaming does not take place and the mixture merely cures. Within the preferred range, the foaming rate of the mixture increases with the power uptake. Above about 200 kW per kilogram of solution or dispersion, the foaming rate does not increase significantly.

The mixture to be expanded is preferably irradiated immediately on emerging from the foaming die. The mixture which is in the process of foaming up as a consequence of temperature elevation and vaporization of the blowing agent, present if appropriate, is applied to circulating belts which form a rectangular duct to shape the foam into correspondingly shaped articles.

Step (3):

The foam obtained in step (2) of the present process is heat treated in step (3) of the present process at a temperature in the range from 120 to 300° C.

In step (3), the foams produced are heated, preferably for 1 to 180 min and more preferably for 5 to 60 min, to temperatures ranging from 120 to 300° C. and preferably from 150 to 250° C., to substantially remove solvent, blowing agent and any formaldehyde from the foam.

In practice, heating the present foams at 220° C. for 30 minutes will be sufficient. The formaldehyde content as measured according to the EU standard EN ISO 14184-1 will then be lower than 40 mg, preferably lower than 30 and more preferably lower than 20 mg per kilogram of foam. In the test method mentioned, a sample of foam is extracted for one hour in hot water at 40° C. and the extracted formaldehyde is analytically determined.

The elastic foams produced according to the present invention have a density in the range from 3 to 50 g*I⁻¹.

The foam produced according to the present invention has the following advantages:
the antimicrobially active reagent has no adverse effect on foam properties, for example structure, mechanicals, abrasiveness,
the foam produced according to the present invention is generally regarded as safe by physiologists,
the foam produced according to the present invention is durable and the antimicrobial active is active for a long period,
the foam produced according to the present invention will remain active after heating to a high sustained-use temperature of 200° C. if inorganic compounds are used as antimicrobials,
the foam produced according to the present invention does not interfere when used in a microwave, since when the antimicrobial actives used are inorganic the amount of elemental metal is too low and/or the particles are too small.

Accordingly, the present invention also provides a foam obtainable by the process of the present invention. The present invention further provides a foam, preferably based on a melamine-formaldehyde condensation product, comprising at least one antimicrobial active uniformly distributed therein.

These foams can be produced as finite or continuous sheets up to 2 meters in height or processed into foam films a few millimeters in thickness.

The present invention further provides a shaped article comprising a foam according to the present invention. Examples of such shaped articles are one-piece or particulate packaging materials for foods or hygiene articles. Further examples are mountings of thin foam fleeces in combination with other foams, fleeces and/or porous materials for filtration. Such filters can be used for example in ventilation/air-conditioning system for example in hospitals, where the biocidal effect can control the spreading of infectious diseases, for example legionella.

The invention also provides for the use of a present foam for thermal and acoustical insulation of buildings and parts of buildings, in particular partitions, but also roofs, facades, doors and floors, and also thermal and acoustical insulation of interiors of land, air and sea vehicles and also low-temperature insulation, for example of refrigerated warehouses, oil tanks and liquefied gas containers. Further applications are the use as insulating wall cladding and as insulating and shock-absorbing packaging material. Owing to the substantial hardness of crosslinked melamine resins, the foams can also be used for slightly abrasive cleaning, grinding and polishing sponges. The open-celled structure of the foams additionally makes it possible for suitable cleaning, grinding and polishing media to be taken up and stored in the interior of the foams. Moreover, for specific cleaning duties, the sponges can be given hydrophobic and oleophobic finishes. Owing to the extremely low formaldehyde emissions and the presence of at least one antimicrobial active, the foams of the present invention are also useful in the hygiene sector, for example in the form of thin fleeces as a wound dressing or as a constituent of infant diapers and incontinence products. The foam of the present invention can further be used as a filter material.

### EXAMPLES

A modified melamine resin foam where the antimicrobial properties are conferred in the course of the foaming operation is produced as follows:

### Example 1

70% by weight of a spray-dried melamine resin (molar ratio 1:1.6) is dissolved in 30% by weight of water. This resin solution is admixed with 3% by weight of an emulsifier formed from an ethoxylated fatty alcohol (more than 20 ethylene oxide units) and also with 3% by weight of formic acid and 10% by weight of pentane, all based on resin. This blowable melamine-formaldehyde precondensate has added to it 0.001% by weight, 0.01% by weight or 0.1% by weight of silver nitrate, based on the precondensate. The mixture is vigorously stirred and subsequently expanded in a foaming mold of polypropylene by being radiated with microwave energy at 2.54 GHz. The foam obtained is aftertreated at a temperature of 180° C. for 60 minutes.

### Example 2

Example 1 is repeated except that silver acetate is added in the same amounts as antimicrobial active.

Compared with foams without added silver salt, the materials produced exhibit no impairments with regard to their mechanical properties or foam structure. Owing to their structure being unimpaired, the sound absorbtion performance and the abrasive cleansing effect are not impaired either.

1.-9. (canceled)

10. A process for producing a foam based on a melamine-formaldehyde condensation product comprising at least one antimicrobial active, comprising the steps of:
(1) preparing a solution or dispersion comprising at least one precondensate of the foam to be produced and at least one antimicrobial active,
(2) foaming the precondensate by heating the solution or dispersion of step (1) to obtain a foam comprising at least one antimicrobial active, and
(3) heat treating the foam obtained in step (2) at a temperature in the range from 120 to 300° C., wherein the at least one antimicrobial active is selected from the group consisting of silver salt, copper salt, zinc salt and organic biocide and wherein the organic biocide is chloroisocyanurate, quarternary ammonium compound, hydantoin, chloromethylisothiazolinone, parabene, triclosan, 2-bromo-2-nitropropane-1,3-diol, phenoxyethanol, hexahydrotriazine or mixtures thereof.

11. The process according to claim 10, wherein the solution in step (1) further comprises at least one emulsifier and/or at least one hardener.

12. The process according to claim 10, wherein the solution or dispersion in step (1) further comprises at least one blowing agent.

13. The process according to claim 10, wherein the heating is effected via hot gases or high frequency irradiation.

14. The process according to claim 10, wherein the at least one antimicrobial active is present in the solution or dispersion in an amount ranging from 0.0001% to 10% by weight, based on the precondensate.

15. The process according to claim 11, wherein the solution or dispersion in step (1) further comprises at least one blowing agent.

16. The process according to claim 15, wherein the heating is effected via hot gases or high frequency irradiation.

17. The process according to claim 16, wherein the at least one antimicrobial active is present in the solution or dispersion in an amount ranging from 0.0001% to 10% by weight, based on the precondensate.

18. A foam obtained by the process according to claim 10.

19. A foam based on a melamine-formaldehyde condensation product comprising at least one antimicrobial active uniformly distributed therein, wherein the at least one antimicrobial active is selected from the group consisting of silver salt, copper salt, zinc salt and organic biocide and wherein the organic biocide is chloroisocyanurate, quarternary ammonium compound, hydantoin, chloromethylisothiazolinone, parabene, triclosan, 2-bromo-2-nitropropane-1,3-diol, phenoxyethanol, hexahydrotriazine or mixtures thereof.

20. A shaped article comprising the foam according to claim 18.

21. A shaped article comprising the foam according to claim 19.

22. Insulation which comprises the foam according to claim 19.

23. A shock-absorbing packaging material which comprises the foam according to claim 19.

24. A filter material which comprises the foam according to claim 19.

25. An abrasive cleaning, grinding and polishing sponge which comprises the foam according to claim 19.
